(19) United States
(12) Patent Application Publication
(10) Pub. No.: US 2023/0002700 A1
(43) Pub. Date: Jan. 5, 2023

(54) PROCESS OF PRODUCING MAGNESIUM SALTS OF PUFAS AND COMPOSITION CONTAINING SAME

(71) Applicant: SILICYCLE INC., Québec (CA)

(72) Inventors: Xiaowei WU, Québec (CA); Christophe MELLON, Québec (CA); Claudia CARPENTIER, Québec (CA); Xavier PIGEON, Québec (CA)

(21) Appl. No.: 17/758,740

(22) PCT Filed: Jan. 29, 2021
(86) PCT No.: PCT/CA2021/050095

§ 371 Date: Jul. 13, 2022

Related U.S. Application Data
(60) Provisional application No. 62/967,666, filed on Jan. 30, 2020.

(51) Int. Cl. C11C 1/02; A23L 33/12; C11C 1/08

(52) U.S. Cl. CPC C11C 1/025; A23L 33/12; C11C 1/08

(57) ABSTRACT

The disclosure relates to a magnesium salt of one or more polyunsaturated fatty acids (PUFAs), a process for preparing same and a composition comprising said magnesium salt of one or more PUFAs and at least one stability enhancer.

### FIELD OF THE DISCLOSURE

The present disclosure relates to a magnesium salt of one or more polyunsaturated fatty acids (PUFAs), a process for preparing same and a composition comprising said magnesium salt of one or more PUFAs and at least one stability enhancer.

### BACKGROUND

Polyunsaturated fatty acids (PUFAs), including omega-3 (ω-3) and omega-6 (ω-6), have been given much attention since the recognition of their beneficial effects on human nutrition and disease prevention three decades ago. Nevertheless, the average daily dietary intake of PUFAs is inadequate and falls far behind the suggested daily intake of 0.65 g in most of the population because of a variety of reasons, such as the dietary patterns of the population and the accessibility of the dietary lipids rich with PUFAs. Dietary supplementation with PUFAs is therefore an alternative to the substitution of commonly used dietary lipids, which usually exist in three forms: triacylglycerol (TAG) form, ethyl ester (EE) form and free acid form (FFA). The bioavailability of PUFAs in FFA and TAG forms has been demonstrated superior to the PUFAs in EE form. In addition, the PUFAs in FFA form have advantages over the TAG form due to the lack of dependence on pancreatic lipase as well as the complex fatty acid profiles in the glycerial backbone of TAG.

It is desired to find a mean to take an adequate dosage of PUFAs to confer the desired benefits while reducing the risk of vitamins overdose as well as an increase in the intake of cholesterol and other saturated fatty acids. The concentrated forms of PUFAs from marine oils have been investigated and several techniques have been developed, such as adsorption chromatography, fractional or molecular distillation, enzymatic splitting, winterization, supercritical fluid extraction and urea complexation. Only a few of them are suitable for large-scale production. Winterization, as a traditional and simple method for the enrichment of PUFAs in certain solvents at a given temperature, has been exploited widely and usually falls into two categories: Category 1: The PUFAs in the form of FFA or EE are concentrated by low-temperature crystallization. Category 2: One PUFA as metal salt (such as EPA) is selectively concentrated by low-temperature crystallization in the presence of others (such as DHA and DPA) from fatty acids.

### SUMMARY OF THE DISCLOSURE

An aspect relates to a composition comprising a magnesium salt of one or more polyunsaturated fatty acids (PUFAs), and at least one stability enhancer, wherein said composition is in solid form at a temperature of about 20-25° C., wherein said composition is comprising at 30%-60% (w/w) of said magnesium salts of one or more PUFAs relative to the total weight of said composition.

A further aspect relates to a process for producing a magnesium salt of one or more polyunsaturated fatty acids (PUFAs) comprising 1) mixing a fat or oil comprising PUFA triglycerides in an alcoholic solution comprising an alcohol, water and an alkali base, at a temperature of between about above 0° C. to about the boiling point of said alcohol, provided that it is less than about 80° C.; wherein the ratio of said water to said alcohol is from about 0.5:99.5 to about 10:90 (v/v), wherein the ratio of said alkali base to said alcoholic solution is from about 1:15 (w/w) to about 1:30(w/w); wherein the ratio of said fat or oil to said solvent is from about 1:3 (w/w) to about 1:6 (w/w) to provide an alcoholic solution comprising PUFA alkali metal salts and precipitated solids; 2) removing the precipitated solids from the alcoholic solution comprising said PUFA alkali salts; optionally washing said precipitated solids with an organic solvent to provide an organic solution comprising said PUFA alkali salts, and combining said alcoholic solution comprising said PUFA alkali salts and said organic solution comprising said PUFA alkali salts, 3) evaporating volatiles from said alcoholic solution or said combined alcoholic and organic solutions to provide a concentrated filtrate; and 4) mixing an amount of water-soluble magnesium salt and said concentrated filtrate in water wherein the amount of said magnesium salt is efficient to reduce the pH to a value lower than about 9 to provide said magnesium salts of one or more PUFAs.

Still a further aspect relates to a method for producing a composition comprising a magnesium salt of one or more polyunsaturated fatty acids (PUFAs), and at least one stability enhancer, the method comprising: A) providing a solid magnesium salt of one or more PUFAs by performing the process as defined herein; B) dispersing the magnesium salts of PUFAs and at least one stability enhancer in a dispersive organic solvent to obtain a dispersion; and C) removing the dispersive organic solvent from the dispersion to obtain a flowable storage-stable powder.

In an embodiment, the PUFAs comprise at least one of omega-3 and omega-6 PUFAs.

In another embodiment, the omega-3 PUFAs comprise at least one of docosahexaenoic acid (C22:6n-3) (DHA), eicosapentaenoic acid (20:5n-3) (EPA) and alpha-linolenic acid (C18:3n-3) (ALA).

In a further embodiment, the omega-3 PUFAs further comprise at least one of eicosatrienoic acid (C20:3(n-3)) (ETE), eicosatetraenoic acid (C20:4 (n-3)) (ETA), heneicosapentaenoic acid (C21:5(n-3)) (HPA), docosapentaenoic acid C22:5(n-3) (DPA), tetracosapentaenoic acid (C24:5(n-3)), and tetracosahexaenoic acid (C24:6(n-3)).

In an additional embodiment, the omega-6 PUFAs comprise at least one of linoleic acid (C18:2n-6) and arachidonic acid (C20:4n-6).

In a further embodiment, the omega-6 PUFAs further comprise at least one of eicosadienoic acid (C20:2(n-6)), dihomo-gamma-linolenic acid (C20:3 (n-6)) (DGLA), docosadienoic acid (C22:2 (n-6)), adrenic acid (C22:4 (n-6)), docosapentaenoic acid (C22:5(n-6)), tetracosatetraenoic acid C24:4(n-6), and tetracosapentaenoic acid C24:5(n-6)).

In an embodiment, the PUFAs are comprised in a fat or oil.

In another embodiment, the alkali base is sodium hydroxide, potassium hydroxide, lithium hydroxide or sodium carbonate.

In a further embodiment, the method encompassed herein comprises in step 4), the water-soluble magnesium salts are added in the solution to provide a range between about 8 to about 9.

In another embodiment, the water-soluble magnesium salts are magnesium sulfate, magnesium chloride, magnesium citrate, magnesium glycinate, magnesium orotate, magnesium L-threonate, or a combination thereof.

In another embodiment, the oil or fat is tuna oil or seal oil.

In a supplemental embodiment, the oil is tuna oil triglyceride comprising 22.9-23.3% DHA and 7.1-7.5% of EPA wt/wt over the total amount of triglyceride.

In an embodiment, the oil is tuna oil triglyceride comprising 23.1% DHA and 7.3% of EPA wt/wt over the total amount of triglyceride.

In a further embodiment, the oil is seal oil triglyceride comprising 7.0-10% DHA, 7-10% of EPA and 3-5% DPA wt/wt over the total amount of triglyceride.

In another embodiment, the oil is seal oil triglyceride comprising 8.2% DHA, 7.0% of EPA and 4.2% DPA wt/wt over the total amount of triglyceride.

In an embodiment, the alcoholic solution comprises at least one of ethanol and methanol.

It is also encompassed a composition obtained by the process described herein.

In another embodiment, the stability enhancer is at least one of tocopherol, a polyamine, ascorbyl palmitate, vitamin E, rosemary extract, carnosic acid, or a combination thereof.

In a further embodiment, the dispersive organic solvent is acetonitrile or propionitrile.

### DETAILED DESCRIPTION

The term “polyunsaturated fatty acid” or “PUFA” as used herein means fatty acid compounds containing two or more ethylenic carbon-carbon double bonds in their carbon backbone. Two major classes of PUFAs are omega-3 and omega-6 PUFAs, characterized by the position of the final double bond in the chemical structure of PUFAs.

Omega-3 PUFAs refer to the position of the final double bond, which in omega-3, the double bond is between the third and fourth carbon atoms from the “omega” or tail end of the molecular chain.

The three most important omega-3 PUFAs are docosahexaenoic acid (DHA), which has 22 carbons and 6 double bonds beginning with the third carbon from the methyl end and is designated as (C22:6n-3), eicosapentaenoic acid (EPA), which is designated as (20:5n-3), and alpha-linolenic acid (ALA) which is designated as (C18:3n-3).

Other omega-3 PUFAs include: Eicosatrienoic acid (ETE) (C20:3(n-3)), Eicosatetraenoic acid (ETA) (C20:4 (n-3)), Heneicosapentaenoic acid (HPA) (C21:5(n-3)), Docosapentaenoic acid (Clupanodonic acid) (DPA) C22:5(n-3), Tetracosapentaenoic acid (C24:5(n-3)), and Tetracosahexaenoic acid (Nisinic acid) (C24:6(n-3)).

Omega-6 PUFAs have their terminal double bond in what is referred to as the omega six-position, meaning the last double bond occurs at the sixth carbon from the omega end of the fatty acid molecule.

Among the omega-6 PUFAs, linoleic acid (C18:2n-6) and arachidonic acid (C20:4n-6) are two of the major omega-6s.

Other omega-6 PUFAs include: Eicosadienoic acid (C20:2(n-6)), Dihomo-gamma-linolenic acid (DGLA) (C20:3 (n-6)), Docosadienoic acid (C22:2 (n-6)), Adrenic acid (C22:4 (n-6)), Docosapentaenoic acid (Osbond acid) (C22:5(n-6)), Tetracosatetraenoic acid C24:4(n-6), and Tetracosapentaenoic acid (C24:5(n-6)).

The terms “fat” and/or “oil” used herein refer to any fat and/or oil containing a level of PUFAs suitable for use in the compositions and methods described herein. The PUFA esters present in the fat or oil are as alkyl esters, triglycerides, diglycerides, monoglycerides, or a mixture thereof. In the case of diglycerides or triglycerides, the glycerol unit may optionally bear a phosphorus derivative (hence the fat and/or oil could be or contain phospholipids).

The term “stability enhancer” as used herein means an agent that is acceptable for use in food or drug compositions that prolongs the stability and shelf life of a composition comprising magnesium salts of PUFAs. It is understood that the stability enhancer should be in an amount efficient to provide an increase in stability and shelf life as assessed by peroxide value (PV), anisidine value (AV) and/or Totox value, known in the art, but also as defined herein. The decrease of at least one of the PV or AV numerical values depends on its original magnitude: very large values, in the hundreds, may be reduced in one treatment to values in the twenties. AV values closer to a regulated value of 25 (say 20 to 50) may be reduced to values around 1 to 5, depending on the species the oil comes from and the amount of stability enhancer added. PV values around 3 to 10 may be reduced to 0.1 to 2, depending on the species the oil comes from and the amount of stability enhancer added. On occasions, the PV value was below detection limits.

The “alkali base” used herein refers to suitable bases which substantially fully solubilize in the aqueous alcoholic solution and are capable of hydrolyzing (saponifying) the ester linkage between the glycerol and fatty acid of the triglycerides. The alkali base could be for example, but not limited to, an alkali hydroxide such as sodium hydroxide, potassium hydroxide, lithium hydroxide and sodium carbonate.

The term “dispersive organic solvent” used herein to disperse magnesium salts of PUFAs refers to any organic solvent which does not dissolve (or at least not substantially or in an amount that would substantially negatively impact the yield) the magnesium salts of PUFAs. As encompassed herein, examples of such dispersive organic solvents are acetonitrile and propionitrile.

In one aspect, there is provided a composition comprising magnesium salts of PUFAs, and at least one stability enhancer, such as polyamines and/or vitamin E, tocopherol, ascorbyl palmitate, rosemary extract and carnosic acid.

In one embodiment, the composition is used as a dietary supplement.

In one embodiment, the composition is comprising said magnesium salt of one or more PUFA in an amount of at least about 30, at least about 35, at least about 40, between 30 to 60, between 35 to 60 or between 40 to 60 on a weight percent basis with respect to the weight of the composition. It should be understood that the percentage of magnesium-PUFA should be similar to those of PUFA because magnesium has a small molecular weight (i.e. 24.305 over 650, that is about a 4% variation).

Any accepted solid food additive can also be introduced into this composition, such as silica dioxide, magnesium hydroxide, cyclodextrins and starch.

In one embodiment, the dispersive organic solvent is acetonitrile, propionitrile or butyronitrile.

In one embodiment, the composition comprises at least one stability enhancer other than an essential oil, preferably at a concentration of: at least about 500 ppm, at least about 1000 ppm, at least about 1500 ppm, at least about 2000 ppm, at least about 3000 ppm, at least about 4000 ppm, between about 500 to about 4000 ppm, between about 1000 to about 3000 ppm.

In one embodiment, the stability enhancer is at least one of tocopherols, polyamines, and ascorbyl palmitates. Other enhancers include: polyamines and/or vitamin E, tocopherol, ascorbyl palmitate, rosemary extract, and carnosic acid.

In one embodiment, the composition comprises tocopherols at a concentration of: at least about 500 ppm, at least about 1000 ppm, at least about 1500 ppm, at least about 2000 ppm, at least about 3000 ppm.

In one embodiment, the composition comprises polyamines at a concentration of: at least about 500 ppm, at least about 1000 ppm, at least about 1500 ppm, at least about 2000 ppm, at least about 3000 ppm.

In one embodiment, the composition comprises tocopherols, polyamines, and ascorbyl palmitates, the tocopherols at a concentration of: at least about 1000 ppm, at least about 1400 ppm, between about 1000 ppm to about 2000 ppm or between about 1400 ppm to about 1600 ppm; the polyamines at a concentration of: at least about 250 ppm, at least about 400 ppm, between about 250 ppm to about 750 ppm or about 400 ppm to about 600 ppm; the acorbyl palmitate at a concentration of: at least about 1000 ppm, at least about 1400 ppm, between about 1000 ppm to about 2000 ppm or between about 1400 ppm to about 1600 ppm.

In one aspect, there is provided a process for producing magnesium salts of PUFAs.

Magnesium metal salts of PUFAs are obtained in a process by removing alkali salts of saturated and monounsaturated free acids from fats and/or oils and then by performing a metathesis reaction on the enriched alkali salts of PUFAs. In an embodiment, the process described herein is a one-step process.

The process comprises saponification by taking advantage of the different solubility of metal salts of saturated fatty acids (SFA), monounsaturated fatty acids (MUFA) and PUFAs.

As discussed above, an aspect relates to a process for producing a magnesium salt of PUFA.

In one embodiment, the initial step is performed under stirring.

In one embodiment, washing is performed by rinsing which is best done with a minimal volume of organic solvents or mixture of solvents which the fatty acid metal salts have least solubility in. Any organic solvent can be used, but preferably the organic is class 3 listed in Q3C guidance, preferably ethyl acetate and ethanol.

In one embodiment, the process further comprises the step of concentrating the solution and adding water.

In one embodiment, the water-soluble magnesium salts are added in the solution until the pH is in the range of less than about 9, between about 8 to about 9, between about 8.3 to about 8.7. In one embodiment, the water soluble magnesium salts are selected from magnesium sulfate, magnesium chloride, magnesium citrate, magnesium glycinate, magnesium orotate, magnesium L-threonate, and a combination thereof.

In one embodiment, the oil or fat is tuna oil and/or seal oil.

In one embodiment, the process is conducted at atmospheric pressure.

In one embodiment, the process can be conducted with or without an inert gas.

In one embodiment, the oil is tuna oil triglyceride comprising: 22.9-23.3% DHA and 7.1-7.5% of EPA, for example 23.1% DHA and 7.3% of EPA wt/wt over the total amount of triglyceride.

In one embodiment, the oil is seal oil triglyceride comprising: 7.0-10% DHA, 7-10% of EPA and 3-5% DPA, for example 8.2% DHA, 7.0% of EPA and 4.2% DPA wt/wt over the total amount of triglyceride.

In one embodiment, the alkali base is at least one of sodium hydroxide, potassium hydroxide and lithium hydroxide.

The exact stoichiometry of the alkali base equivalent to the fat or oil is impossible to determine for all fats and oils because of the indefinite molecular weight of various fish oils. The source of fat or oil differs from one to another and may contain different species proportions, such as the variety of proportion of triglycerides, diglycerides and monoglycerides. However, as all the glycerides will be fully hydrolyzed to fatty acids with the carbon length of C₁₄-C₂₄, a useful estimation of the average length of carbon chain is C19. Thus, as encompassed herein, the molecular weight 307 g/mol may be used to estimate the amount of alkali base used for saponification. Excess amount of alkali base is used to ensure the complete hydrolysis.

In one embodiment, the alcoholic solution comprises ethanol where the proportion of water to ethanol is in the range of from about 0.5:99.5 to about 10:90 (v/v), or from about 2:98 to about 5:95 (v/v), to ensure complete saponification as evidenced by the absence of all detectable ester forms (triglycerides, diglycerides, monoglycerides and ethanolic esters) in the final product by thin-layer chromatography (TLC) or any other methods known in the art.

In a further embodiment, the proportion of water to ethanol is about 5:95 (v/v).

In one embodiment, the alcoholic solution comprises methanol where the proportion of water to methanol is in the range of from about 0.5:99.5 to about 10:90 (v/v), or from about 2:98 to about 5:95 (v/v), to ensure complete saponification as evidenced by the absence of all detectable ester forms (triglycerides, diglycerides, monoglycerides and esters) in the final product by thin-layer chromatography (TLC) or any other methods known in the art.

In one embodiment, the saponification is conducted at any temperature of less than about 80° C., less than about 60° C., between about 0° C. to about 80° C., between about 20° C. to about 50° C. In a preferred embodiment, the saponification is conducted at room temperature (i.e. between about 20-25° C.).

In one embodiment, the formed solid comprises SFAs and MUFAs.

In one embodiment, the formed solid may be separated from the solution by any physical means to separate a liquid from a solid known by a person skilled in the art which includes decantation, filtration, pressing, centrifuge, chromatography and the likes.

In one embodiment, to form water insoluble fatty acid magnesium salts precipitate, the solution can be optionally rinsed, and the solvent can be removed or partially removed before the addition of the water-soluble magnesium salt solution consisting of a sufficient amount of metal ions.

Excess amount of water-soluble magnesium salts is used to ensure the complete formation of PUFAs concentrate as salts of magnesium. For example, the amount of magnesium salts required to precipitate 1 mole of fatty acid is 0.5 mole. In one embodiment, 0.52 to 2.0 equivalents is added.

As discussed above, it is provided a composition comprising a magnesium salt of PUFA, and at least one stability enhancer.

In one embodiment, it is encompassed that the magnesium salts of PUFAs are separated from their solvent. In a further embodiment, the separation is performed by any physical means to separate a liquid from a solid known by a person skilled in the art which includes decantation, filtration, pressing, centrifuge, chromatography and the likes.

In one embodiment, a further step of drying, such as by vacuum drying, is encompassed.

In one embodiment, the dispersive organic solvent is acetonitrile.

In one embodiment, at least one stability enhancer is one of tocopherols, polyamines or ascorbyl palmitates.

In one embodiment, the method further comprises producing a fine powder under reduced pressure at 0° C.-70° C. depending the properties of the equipment used.

The oxidative status of the obtained composition may be quantified by peroxide value (PV), anisidine value (AV) and Totox value. PV is a measure of the level of the primary oxidation products (lipid hydroperoxides) in the product, which is specified in milliequivalents O₂ per kg of sample, while the AV is an unspecific measure of saturated and unsaturated carbonyl compounds. Totox=2*PV+AV.

The following detailed description is intended to illustrate the disclosure, and not to limit it.

### SAMPLE CHARACTERIZATION

All the reagents are either received or purchased from the chemical companies. No additional purification is performed on all the reagents.

Food Lab Analyzer: Among several techniques known in the art for determining the oxidative levels of a sample. The CDR FoodLab® Junior analyzer was used as described herein for determining peroxide value (PV) and anisidine value (AV). The procedures are described as below.

The solid product 0.5 g was dissolved in 2 mL of MeOH and HCl solution with the ratio of 1:10 (v/v). The mixture was stirred for 5 minutes, followed by the addition of 5 mL of water. The mixture was extracted with 3 mL of Hexane containing 100 ppm Butylated hydroxytoluene (BHT). The organic layer was dried over MgSO₄, filtrated and evaporated under reduced pressure at the temperature of 0-70° C. to obtain the fish oil in free acid form, which was evaluated with the CDR FoodLab® Junior analyzer to get anisidine and peroxide values using the Food Lab analyzer.

Gas chromatography-mass spectrometry (GC-MS): The PUFAs concentrates in the ester form were determined by gas chromatography-mass spectrometry (GC-MS).

Esterification of PUFAs: Around 25 mg of FFA or FFA salts was charged in a sealed tube, and 2 ml of a solution of 2% H₂SO₄ was added to generate a homogenous solution, which was then heated (without any agitation) at 80° C. for 30 minutes. Followed by the addition of 2 ml of saturated NaHCO₃ aqueous solution after the solution was cooled down to the room temperature. The FFA in ester form was extracted with 8-10 ml of 100 ppm BHT Hexanes once. Subsequently, the organic layer was dried over MgSO₄ analysed by GC-MS.

### EXAMPLES

In the following examples, a rotor-stator homogenizer is used for the mixing process. Typically, the homogenizer speed is from 50 rpm to 500 rpm, preferably, from 100-200 rpm.

### Example 1: The Preparation of Fatty Acid Magnesium Salt from Tuna Oil Triglyceride from MgSO₄ with 200 mL of Ethanol

A 2 L of 3-neck round bottle glassware was charged with 200 mL of 95% ethanol, and followed by the addition of 10 g of NaOH. The mixture was stirred until a homogenous solution was obtained. Subsequently, 50 g of tuna oil triglyceride with 23.1% DHA and 7.3% of EPA wt/wt over the total amount of triglyceride, exhibiting a PV of 40.2 meqO₂/Kg and an AV of 6.8 A/g, was added to the mixture and stirred at the speed of 200 rpm with the overhead stirrer at room temperature until the reaction was completed by thin layer chromatography (TLC). The formed solids were removed by filtration, and washed with ethyl acetate. The obtained filtrate was concentrated and 600 mL of H₂O was added. The mixture was stirred until the homogenous solution was obtained. Then 10% of MgSO₄ aqueous solution was added until a pH of 8-9 was obtained. The generated precipitate was filtered off and washed with plenty of water, subsequently vacuum dried to produce a solid, which was further dispersed in acetonitrile containing antioxidants of tocopherols palmitate to generate a free-flowing powder with 2600 ppm tocopherol, a PV of 5.84 meqO₂/Kg and an AV of 1.4 A/g. The PUFAs magnesium salts comprising 64% of ω-3 wt/wt over the total amount of PUFAs (EPA 15%; DHA 49%) were produced with the yield of 69%. Based on the above data, the saturated and/or monounsaturated fatty magnesium salts should be in an amount of about 36%.

### Example 2: The Preparation of Fatty Acid Magnesium Salt from Tuna Oil Triglyceride from MgSO₄ with 150 mL of Ethanol

A 2 L of 3-neck round bottle glassware was charged with 150 mL of 95% ethanol, and followed by the addition of 10 g of NaOH. The mixture was stirred until the homogenous solution was obtained. Subsequently, 50 g of tuna oil triglyceride with 23.1% DHA and 7.3% of EPA (wt/wt over the total amount of triglyceride) exhibiting a PV of 40.2 meqO₂/Kg and an AV of 6.8 A/g, was added to the mixture and stirred at the speed of 200 rpm with the overhead stirrer at room temperature until the reaction was completed, identified with TLC. The formed solids were removed by filtration, and washed with ethyl acetate. The obtained filtrate was concentrated and 600 mL of H₂O was added. The mixture was stirred until the homogenous solution was obtained. Then, 10% of MgSO₄ aqueous solution was added until a pH of 8-9 was obtained. The generated precipitate was filtrated and washed with plenty of water, and subsequently was vacuum dried to produce a solid, which was further dispersed in acetonitrile containing antioxidants of tocopherols, polyamines and ascorbyl palmitate to generate a free-flowing powder with 1500 ppm tocopherols, 500 ppm polyamines and 1500 ppm ascorbyl palmitate, exhibiting a PV of 1.56 meqO₂/Kg and an AV of <0.5 A/g. The PUFAs concentrated fatty acid metal salts comprising 66% of ω-3 (EPA 16%; DHA 50%) were produced with the yield of 44%.

### Example 3: The Preparation of Fatty Acid Magnesium Salt from Tuna Oil Triglyceride with Mg(CH₃COO)₂

A 2 L of 3-neck round bottle glassware was charged with 200 mL of 95% ethanol, and followed by the addition of 10 g of NaOH. The mixture was stirred until the homogenous solution was obtained. Subsequently, 50 g of tuna oil triglyceride with 23.1% DHA and 7.3% of EPA (wt/wt over the total amount of triglyceride), exhibiting a PV of 40.2 meqO₂/Kg and an AV of 6.8 A/g, was added to the mixture and stirred at the speed of 200 rpm with the overhead stirrer at room temperature until the reaction was completed, identified with TLC. The formed solids were removed by filtration, and washed with ethyl acetate. The obtained filtrate was concentrated and 600 mL of H₂O was added. The mixture was stirred until the homogenous solution was obtained. Then, 10% of Mg(CH₃COO)₂ aqueous solution was added until a pH of 8-9 was obtained. The generated precipitate was filtrated and washed with plenty of water, and subsequently vacuum dried to produce a solid, which was further dispersed in acetonitrile containing antioxidants of tocopherols, polyamines and ascorbyl palmitate to generate a free-flowing powder with 1500 ppm tocopherols, 500 ppm polyamines and 1500 ppm ascorbyl palmitate, exhibiting a PV of 2.42 meqO₂/Kg and an AV of <0.5 A/g. The PUFAs concentrated fatty acid metal salts comprising 61% of ω-3 (EPA 14%; DHA 47%) were produced with the yield of 69%.

### Example 4: The Preparation of Fatty Acid Magnesium Salt from Tuna Oil Triglyceride with MgCl₂

A 2 L of 3-neck round bottle glassware was charged with 200 mL of 95% ethanol, and followed by the addition of 10 g of NaOH. The mixture was stirred until the homogenous solution was obtained. Subsequently, 50 g of tuna oil triglyceride with 23.1% DHA and 7.3% of EPA (wt/wt over total amount of tryglyceride), exhibiting a PV of 40.2 meqO₂/Kg and an AV of 6.8 A/g, was added to the mixture and stirred at the speed of 200 rpm with the overhead stirrer at room temperature until the reaction was completed, identified with TLC. The formed solids were removed by filtration, and washed with ethyl acetate. The obtained filtrate was concentrated and 600 mL of H₂O was added. The mixture was stirred until the homogenous solution was obtained. Then, 10% of MgCl₂ aqueous solution was added until a pH of 8-9 was obtained. The generated precipitate was filtrated and washed with plenty of water, and subsequently vacuum dried to produce a solid, which was further dispersed in acetonitrile containing antioxidants of tocopherols, polyamines and ascorbyl palmitate to generate a free-flowing powder with 1500 ppm tocopherols, 500 ppm polyamines and 1500 ppm ascorbyl palmitate, exhibiting a PV of 2.38 meqO2/Kg and an AV of <0.5 A/g. The PUFAs concentrated fatty acid metal salts comprising 77% of ω-3 (EPA 18%; DHA 59%) were produced with the yield of 65%.

### Example 5: The Preparation of Fatty Acid Calcium Salt from Seal Oil Triglyceride Using Mg(CH₃COO)₂

A 2 L of 3-neck round bottle glassware was charged with 200 mL of 95% ethanol, and followed by the addition of 10 g of NaOH. The mixture was stirred until the homogenous solution was obtained. Subsequently, 50 g of seal oil triglyceride with 8.2% DHA, 7.0% of EPA and 4.2% of DPA (wt/wt over total amount of tryglyceride), exhibiting a PV of >50 meqO₂/Kg and an AV of 47.7 A/g, was added to the mixture and stirred at the speed of 200 rpm with the overhead stirrer at room temperature until the reaction was completed, identified with TLC. The formed solids were removed by filtration, and washed with ethyl acetate. The obtained filtrate was concentrated and 600 mL of H₂O was added. The mixture was stirred until the homogenous solution was obtained. Then, 10% of CaCl₂.2H₂O aqueous solution was added until a pH of 8-9 was obtained. The agglomerated solid was generated, and the water was decanted, and subsequently vacuum dried to produce a solid, which was further dispersed in acetonitrile containing antioxidants of tocopherols, polyamines and ascorbyl palmitate to generate a free-flowing powder with 1500 ppm tocopherols, 500 ppm polyamines and 1500 ppm ascorbyl palmitate, exhibiting a PV of 0.96 meqO₂/Kg and an AV of <0.5 A/g. The PUFAs concentrated fatty acid metal comprising 44% of ω-3 (EPA 19%; DHA 20%; DPA:5%) were produced with the yield of 57%.

While the present disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims.

1: A process for producing a magnesium salt of one or more polyunsaturated fatty acids (PUFAs) comprising
1) mixing a fat or oil comprising PUFA triglycerides in an alcoholic solution comprising an alcohol, water and an alkali base, at a temperature of between about above 0° C. to about the boiling point of said alcohol, provided that it is less than about 80° C.;
wherein the ratio of said water to said alcohol is from about 0.5:99.5 to about 10:90 (v/v),
wherein the ratio of said alkali base to said alcoholic solution is from about 1:15 (w/w) to about 1:30(w/w);
wherein the ratio of said fat or oil to said solvent is from about 1:3 (w/w) to about 1:6 (w/w);
to provide an alcoholic solution comprising PUFA alkali metal salts and precipitated solids;
2) removing the precipitated solids from the alcoholic solution comprising said PUFA alkali salts;
optionally washing said precipitated solids with an organic solvent to provide an organic solution comprising said PUFA alkali salts, and combining said alcoholic solution comprising said PUFA alkali salts and said organic solution comprising said PUFA alkali salts;
3) evaporating volatiles from said alcoholic solution or said combined alcoholic and organic solutions to provide a concentrated filtrate; and
4) mixing an amount of water-soluble magnesium salt and said concentrated filtrate in water wherein the amount of said magnesium salt is efficient to reduce the pH to a value lower than about 9 to provide said magnesium salts of one or more PUFAs.

2: The process of claim 1, wherein said PUFAs comprise at least one of omega-3 and omega-6 PUFAs.

3: The process of claim 2, wherein said omega-3 PUFAs comprise at least one of docosahexaenoic acid (C22:6n-3) (DHA), eicosapentaenoic acid (20:5n-3) (EPA) and alpha-linolenic acid (C18:3n-3) (ALA).

4: The process of claim 2, wherein said omega-3 PUFAs further comprise at least one of eicosatrienoic acid (C20:3(n-3)) (ETE), eicosatetraenoic acid (C20:4 (n-3)) (ETA), heneicosapentaenoic acid (C21:5(n-3)) (HPA), docosapentaenoic acid C22:5(n-3) (DPA), tetracosapentaenoic acid (C24:5(n-3)), and tetracosahexaenoic acid (C24:6(n-3)).

5: The process of claim 2, wherein said omega-6 PUFAs comprise at least one of linoleic acid (C18:2n-6) and arachidonic acid (C20:4n-6).

6: The process of claim 2, wherein said omega-6 PUFAs further comprise at least one of eicosadienoic acid (C20:2(n-6)), dihomo-gamma-linolenic acid (C20:3 (n-6)) (DGLA), docosadienoic acid (C22:2 (n-6)), adrenic acid (C22:4 (n-6)), docosapentaenoic acid (C22:5(n-6)), tetracosatetraenoic acid C24:4(n-6), and tetracosapentaenoic acid C24:5(n-6)).

7: The process of claim 1, wherein said PUFAs are comprised in a fat or oil.

8: The process of claim 1, wherein said alkali base is sodium hydroxide, potassium hydroxide, lithium hydroxide or sodium carbonate.

9: The process of claim 1, wherein in said step 4), the water-soluble magnesium salts are added in the solution to provide a range between about 8 to about 9.

10: The process of claim 1, wherein said water-soluble magnesium salts are magnesium sulfate, magnesium chloride, magnesium citrate, magnesium glycinate, magnesium orotate, magnesium L-threonate, or a combination thereof.

11: The process of claim 1, wherein said oil or fat is tuna oil or seal oil.

12: The process of claim 1, wherein said oil is tuna oil triglyceride comprising 22.9-23.3% DHA and 7.1-7.5% of EPA wt/wt over the total amount of triglyceride; wherein said oil is tuna oil triglyceride comprising 23.1% DHA and 7.3% of EPA wt/wt over the total amount of triglyceride; wherein said oil is seal oil triglyceride comprising 7.0-10% DHA, 7-10% of EPA and 3-5% DPA wt/wt over the total amount of triglyceride; or wherein said oil is seal oil triglyceride comprising 8.2% DHA, 7.0% of EPA and 4.2% DPA wt/wt over the total amount of triglyceride.

13-15. (canceled)

16: The process of claim 1, wherein said alcoholic solution comprises at least one of ethanol and methanol.

17: A composition obtained by the process of claim 1 comprising a magnesium salt of one or more polyunsaturated fatty acids (PUFAs), and at least one stability enhancer,
wherein said composition is in solid form at a temperature of about 20-25° C., and
wherein said composition comprises 30%-60%% (wt/wt) of said magnesium salts of one or more PUFAs relative to the total weight of said composition.

18: The composition of claim 17, wherein said PUFAs comprise at least one of omega-3 and omega-6 PUFAs.

19: The composition of claim 18, wherein said omega-3 PUFAs comprise at least one of docosahexaenoic acid (C22:6n-3) (DHA), eicosapentaenoic acid (20:5n-3) (EPA) and alpha-linolenic acid (C18:3n-3) (ALA).

20: The composition of claim 18, wherein said omega-3 PUFAs further comprise at least one of eicosatrienoic acid (C20:3(n-3)) (ETE), eicosatetraenoic acid (C20:4 (n-3)) (ETA), heneicosapentaenoic acid (C21:5(n-3)) (HPA), docosapentaenoic acid C22:5(n-3) (DPA), tetracosapentaenoic acid (C24:5(n-3)), and tetracosahexaenoic acid (C24:6(n-3)).

21: The composition of claim 18, wherein said omega-6 PUFAs comprise at least one of linoleic acid (C18:2n-6) and arachidonic acid (C20:4n-6).

22: The composition of claim 18, wherein said omega-6 PUFAs further comprise at least one of eicosadienoic acid (C20:2(n-6)), dihomo-gamma-linolenic acid (C20:3 (n-6)) (DGLA), docosadienoic acid (C22:2 (n-6)), adrenic acid (C22:4 (n-6)), docosapentaenoic acid (C22:5(n-6)), tetracosatetraenoic acid C24:4(n-6), and tetracosapentaenoic acid C24:5(n-6)).

23-26. (canceled)
